(19) United States
(12) Patent Application Publication
(10) Pub. No.: US 2019/0118926 A1
(43) Pub. Date: Apr. 25, 2019

(54) FUSELAGE STRUCTURE FOR AN AIRCRAFT, AND AIRCRAFT

(71) Applicant: Airbus Operations GmbH, Hamburg (DE)

(72) Inventors: Memis Tiryaki, Hamburg (DE); Hermann Benthien, Hamburg (DE); Wolfgang Eilken, Hamburg (DE)

(21) Appl. No.: 16/156,582

(22) Filed: Oct. 10, 2018

(30) Foreign Application Priority Data
Oct. 25, 2017 (DE) 102017219073.6

(51) Int. Cl. B64C 1/10; B64C 1/06

(52) U.S. Cl. CPC B64C 1/10; B64C 1/069

(57) ABSTRACT

A fuselage structure for an aircraft, comprising a fuselage vessel and a pressure bulkhead arranged in an end region of the fuselage vessel and having a central region extending in a planar manner and a connection region adjoining the central region in a radial direction and surrounding the central region and being secured to the fuselage vessel. The pressure bulkhead divides the fuselage vessel with respect to the longitudinal direction into a first region for subjecting to an internal pressure and a second region for subjecting to an external pressure which is lower than the internal pressure. The central region of the pressure bulkhead has an arching in the direction of the first region of the fuselage vessel.

### CROSS-REFERENCES TO RELATED APPLICATIONS

This application claims the benefit of the German patent application No. 10 2017 219 073.6 filed on Oct. 25, 2017, the entire disclosures of which are incorporated herein by way of reference.

### BACKGROUND OF THE INVENTION

The present invention relates to a fuselage structure for an aircraft, and to an aircraft.

Pressurized cabins or pressurized regions in which a virtually constant internal pressure prevails during the flight are customarily provided inside the fuselage structure of aircraft. The pressurized regions, such as, for example, the passenger cabin or the cargo area are separated in a pressure-tight manner from non-pressurized regions, in which the respectively present ambient pressure prevails, by means of what are referred to as pressure bulkheads.

A pressure bulkhead is customarily arranged in a rear end portion of the fuselage structure and secured to the fuselage structure by means of securing devices. Since, depending on the flight height, the pressure differences occurring between a pressurized and non-pressurized region can be relatively large, the pressure bulkhead itself and the associated securing devices are heavily loaded mechanically. Domed or dome-shaped pressure bulkheads which are arched in the direction of the non-pressurized region have proven advantageous here. A fuselage of an aircraft comprising a pressure bulkhead of this type is described, for example, in EP 3 064 430 A1.

Since system components of the aircraft, such as, for example, kinematics for actuating control surfaces of the aircraft, are frequently arranged in the non-pressurized region positioned behind the pressure bulkhead, it is desirable for the pressure bulkhead to project as little as possible into the region. Furthermore, it is desirable to arrange the pressure bulkhead as far as possible at the end of the fuselage structure in order to obtain as large an economically usable pressurized region as possible. Accordingly, a pressure bulkhead in the form of a flat disc is described in U.S. Pat. No. 5,899,412 A. A multiplicity of radially extending webs are provided for mechanically reinforcing this pressure bulkhead.

### SUMMARY OF THE INVENTION

It is an object of the present invention to integrate a pressure bulkhead in a fuselage structure of an aircraft in an improved, in particular space-saving manner

According to a first aspect of the invention, a fuselage structure for an aircraft, for example an airplane, is provided. The fuselage structure has a fuselage vessel extending in a longitudinal direction, and a pressure bulkhead which is arranged in an end region of the fuselage vessel. The pressure bulkhead has a central region extending in a planar manner and a connection region which adjoins the central region in a radial direction and surrounds the central region and is secured to the fuselage vessel. The pressure bulkhead, which may also be referred to as a pressure dome, divides the fuselage vessel with respect to the longitudinal direction into a first region for subjecting to an internal pressure and a second region for subjecting to an external pressure which is lower than the internal pressure. In particular, the central region of the pressure bulkhead has an arching in the direction of the first region of the fuselage vessel.

According to the invention, a fuselage structure comprising an elongate, for example cylindrical or partially conical fuselage vessel, which defines an interior space, is therefore provided. A first region of the interior space is provided in the form of a pressurized region, i.e., a region in which an approximately constant internal pressure which is independent of the flight height of an aircraft, can be set. A second region of the interior space is provided in the form of a non-pressurized region, i.e., a region, the pressure of which approximately corresponds to the respective ambient pressure which, during a flight of an aircraft, is typically lower than the pressure in the first region. The first and the second region of the fuselage vessel are divided in the longitudinal direction by an arched pressure dome extending in a planar manner, or a pressure bulkhead. For this purpose, the pressure bulkhead is secured with a connection region to the fuselage vessel by means of securing devices, for example rivets, bolts, clamps or the like.

The pressure bulkhead has, in particular, a central region which runs in an arched or curved manner, extends in a planar manner and is surrounded in the radial direction by the connection region. The pressure bulkhead is arranged, according to the invention, inside the fuselage vessel in such a manner that the central region is arched or bulges into the first region. That is to say, as seen from the first region of the fuselage vessel, the central region of the pressure bulkhead is curved convexly. The connection region of the pressure bulkhead can thereby be arranged with respect to the longitudinal direction further in the direction of the second region of the fuselage vessel than is the case with a customary arrangement of a pressure bulkhead, in which the latter is curved concavely, as seen from the first region. This affords the advantage that the first region is enlarged. At the same time, because of the mechanically resistant, arched shape of the pressure bulkhead, the number of reinforcing structures possibly necessary for the mechanical reinforcement, such as rods or ribs, can be reduced in comparison to a disc-like configuration of the pressure bulkhead.

The pressure bulkhead has a center axis which runs through the area center of gravity of the pressure bulkhead or of the pressure dome, wherein the center axis and the radial direction are perpendicular to each other. The pressure bulkhead can optionally be configured as a component which is point-symmetric with respect to a center axis. The pressure bulkhead is arranged in the fuselage vessel in such a manner that the center axis extends along the longitudinal direction of the fuselage vessel.

According to one embodiment of the fuselage structure, it is provided that the direction of arching is changed twice between two points of a peripheral edge of the pressure bulkhead, the points lying opposite each other in the radial direction. Accordingly, the pressure bulkhead has a convexly and a concavely curved region. This results in a mechanically advantageous distribution of stress with a space-saving extent of the pressure bulkhead along the center axis.

In particular, it can be provided that the central region of the pressure bulkhead is arched convexly in an inner region, with respect to the radial direction, in the direction of the first region of the fuselage vessel, i.e., as seen from the first region, and is arched concavely in an outer region, with respect to the radial direction, in the direction of the second region of the fuselage vessel, i.e., as seen from the first region.

It is optionally provided here that the inner region of the central region of the pressure bulkhead forms a plateau. The radius of curvature of the inner region of the central region becomes smaller in the radial direction here. The extent of the pressure bulkhead along its center axis can thereby be reduced further.

According to a further embodiment of the fuselage structure, the central region of the pressure bulkhead is arched in a dome-like manner. Accordingly, the central region has as a whole, or in the inner region of the central region, a constant radius of curvature or is arched in a spherical-segment-shaped manner This configuration has a particularly high degree of mechanical stability.

According to a further embodiment, it can be provided that the connection region of the pressure bulkhead continues the profile of the central region in a planar manner. Accordingly, the connection region therefore continues the curvature profile of the central region. The stresses in the transition region between the connection region and central region are thereby advantageously reduced.

As an alternative thereto, the connection region can be of wedge-shaped design. A structure forming a peripheral end of the pressure bulkhead and having a wedge-shaped cross section is provided here as the connection region. Stresses can thereby also be advantageously reduced.

According to a further embodiment of the fuselage structure, the central region and the connection region of the pressure bulkhead are formed integrally.

According to a further embodiment, the pressure bulkhead is formed from a fiber composite material or a metal material. For example, aluminum alloys are suitable as the metal material. As the fiber composite material, use can be made, in particular, of a fiber-reinforced plastic, for example a thermoplastic or thermosetting material reinforced with carbon or glass fibers.

According to a further aspect of the invention, an aircraft comprising a fuselage structure according to one of the above-described embodiments is provided. The pressure bulkhead can be arranged here, in particular, in an end portion of the fuselage structure, for example in the vicinity of the rear of the aircraft.

In this connection, the first region of the fuselage vessel can, in particular, form a passenger cabin and/or a cargo hold of the aircraft.

According to a further embodiment of the aircraft, system components are arranged in the second region of the fuselage vessel. The system components can be, in particular, a lever arrangement for actuating aerodynamic control surfaces of the aircraft.

In respect of direction indications and axes, in particular direction indications and axes which relate to the profile of physical structures, extension of an axis, a direction or a structure “along” another axis, direction or structure is understood herein to mean that they, in particular the tangents resulting at a particular point on the structures, each extend at an angle of less than 45°, preferably less than 30° and, in particular, preferably extend parallel to one another.

In respect of direction indications and axes, in particular direction indications and axes which relate to the profile of physical structures, extension of an axis, a direction or a structure “transversely” with respect to another axis, direction or structure is understood herein to mean that they, in particular the tangents resulting at a particular point on the structures, each extend at an angle of greater than or equal to 45°, preferably greater than or equal to 60° and, in particular, preferably extend perpendicularly to one another.

Here, components formed “as a single piece,” “as a single part,” “integrally” or “in one piece” are understood in general to mean that these components are present as a single part forming a material unit and, in particular, are produced as such, wherein it is not possible to detach one from the other component without destroying the material cohesion.

### BRIEF DESCRIPTION OF THE DRAWINGS

The invention is explained below with reference to the figures of the drawings. In the figures:

FIG. 1 shows a schematic view of an aircraft according to one exemplary embodiment of the invention;

FIG. 2 shows a schematic sectional view of a fuselage structure according to one exemplary embodiment of the present invention;

FIG. 3 shows a top view of a pressure bulkhead of a fuselage structure according to one exemplary embodiment of the present invention;

FIG. 4 shows a schematic sectional view of one exemplary embodiment of a pressure bulkhead, the sectional view arising in a section along the line A-A shown in FIG. 3;

FIG. 5 shows a schematic sectional view of a further exemplary embodiment of a pressure bulkhead, the sectional view arising in a section along the line A-A shown in FIG. 3;

FIG. 6 shows a schematic sectional view of a further exemplary embodiment of a pressure bulkhead, the sectional view arising in a section along the line A-A shown in FIG. 3;

FIG. 7 shows a schematic sectional view of a further exemplary embodiment of a pressure bulkhead; and

FIG. 8 shows a schematic sectional view of a further exemplary embodiment of a pressure bulkhead.

In the figures, the same reference signs denote identical or functionally identical components unless otherwise stated.

### DETAILED DESCRIPTION OF THE PREFERRED EMBODIMENTS

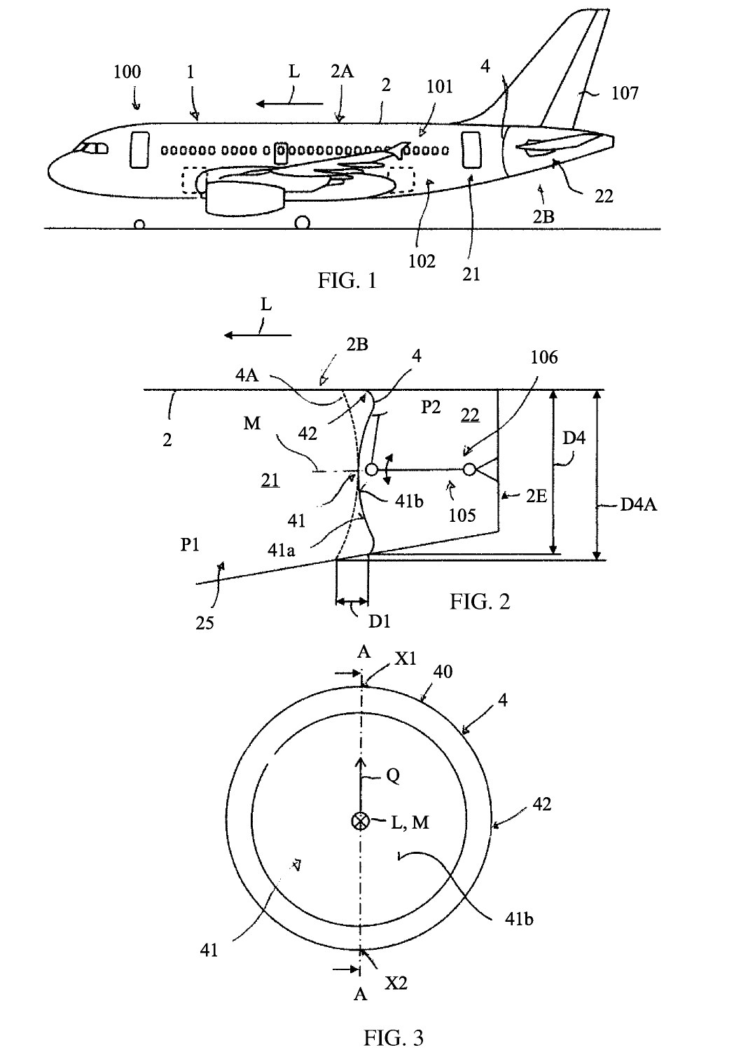

FIG. 1 schematically shows a side view of an aircraft 100. The aircraft 100 is illustrated by way of example as a passenger aircraft in FIG. 1. The aircraft 100 has a fuselage structure 1 with a fuselage vessel 2 and a pressure bulkhead 4.

As shown in FIG. 1, the fuselage vessel 2 extends in a longitudinal direction L and, as illustrated by way of example, can have a cylindrical main region and an end region 2B. The end region 2B can be formed in a conically tapering manner, in particular in the longitudinal direction L, as is shown by way of example in FIG. 1.

FIG. 2 schematically shows a sectional view of the fuselage structure 1 in the region of the end region 2B of the fuselage vessel 2. The pressure bulkhead 4, which may also be referred to as a pressure dome, is arranged in the end region 2B of the fuselage vessel 2. As can be seen in FIGS. 1 and 2, the pressure bulkhead 4 divides the fuselage vessel 2 with respect to the longitudinal direction L into a first region 21 and a second region 22. The first region 21 can, in particular, form a passenger cabin 101 and/or the cargo hold 102 of the aircraft 100. The second region 22 serves for accommodating system components 105, such as a lever arrangement 106, as is shown by way of example and schematically in FIG. 2. This lever arrangement 106 serves, for example, for actuating aerodynamic control surfaces 107, such as the rudder, as is shown by way of example in FIG. 1. The first region 21 of the fuselage vessel 2 is provided for subjecting to an internal pressure P1 which is kept as constant as possible during the flight. The second region 22 is provided for subjecting to an external pressure P2 which is lower than the internal pressure P1. Since the external pressure or ambient pressure P2 changes during a flight depending on the flight height, a pressure difference occurs between the first region and the second region 21, 22 of the fuselage vessel 2. The pressure bulkhead 4 serves for the pressure-tight separation of the first and the second region 21, 22 of the fuselage vessel 2.

As is shown in particular in FIG. 3, the pressure bulkhead 4 has a central region 41 extending in a planar manner and a connection region 42 which adjoins the central region 41 in a radial direction Q and surrounds the central region. As is shown in FIGS. 1 and 2, the pressure bulkhead 4 is secured with the connection region 42 to the fuselage vessel 2, in particular by means of securing devices (not illustrated), such as, for example, rivets, screws, bolts, clamps or the like. The pressure bulkhead has a center axis M which runs through the area center of gravity of the pressure bulkhead 4 or the pressure dome, wherein the center axis and the radial direction Q are perpendicular to each other. In the case of the pressure bulkhead 4 shown by way of example in FIG. 3, the connection region 42 forms a circular peripheral wheel or defines a circular edge line 40 of the pressure bulkhead 4. In general, the pressure bulkhead 4 can be configured as a component which is point-symmetric with respect to a center axis M.

As FIG. 2 shows, the pressure bulkhead 4 is arranged in the fuselage vessel in such a manner that the center axis M extends along the longitudinal direction L of the fuselage vessel 2. As is furthermore schematically shown in FIG. 2 and will be explained in more detail below, the central region 41 of the pressure bulkhead 4 has an arching in the direction of the first region 21 of the fuselage vessel 2. In general, the pressure bulkhead 4 therefore has, in the central region 41, a first surface 41a, which is at least partially convexly curved, and a second surface 41b, which is positioned opposite the first surface 41a and is at least partially concavely curved. In order to form the fuselage structure 1, the pressure bulkhead 4 is arranged in the interior space 25 defined by the fuselage vessel 2, wherein the first surface 41a of the central region 41 of the pressure bulkhead 4 faces the first region 21, i.e., the region provided for subjecting to the internal pressure, for example the passenger cabin 101.

As can be seen in FIG. 2, by means of this arrangement and configuration of the pressure bulkhead 4 in comparison to an otherwise customary arrangement and configuration of a pressure bulkhead, the connection region 42 of the pressure bulkhead 4 can be arranged closer to the axial end of the fuselage vessel 2. Such a customary arrangement and configuration of a pressure bulkhead is indicated by the dashed line 4A in FIG. 2. As FIG. 2 schematically shows, by means of the arching according to the invention of the central region 41 of the pressure bulkhead 4 in the direction of the first region 21 of the fuselage vessel 2, the connection region 42 can be arranged closer to the axial end 2E of the fuselage vessel 2 by the distance D1 with respect to the longitudinal direction L. In this connection, because of the arching of the central region 41, the freedom of movement of the system components 105 in the second region 22 is only slightly restricted, if at all, while additional economically useable space is created in the first region 21. In the case in which the end region 2B of the fuselage vessel 2 tapers in the direction of the axial end 2E, as is shown by way of example in FIGS. 1 and 2, the configuration and arrangement of the pressure bulkhead 4 shown in FIGS. 1 and 2 result in a reduction in the diameter D4 of the pressure bulkhead in comparison to the diameter D4A of a pressure bulkhead 4A configured and arranged in a customary manner. This leads to a reduction in weight of the pressure bulkhead 4 and at the same time to a reduction in the mechanical loading.

FIGS. 4 to 8 each show sectional views of pressure bulkheads 4. In general, the pressure bulkhead 4 has a first surface 4a and a second surface 4b placed opposite the latter. The first surface 4a of the pressure bulkhead 4 faces the region 21 in a state in which the pressure bulkhead 4 is arranged in the fuselage vessel 2. The second surface 4b of the pressure bulkhead 4 faces the second region 22 or the axial end 2E of the fuselage vessel 2 in a state in which the pressure bulkhead 4 is arranged in the fuselage vessel 2. In general, the first surface 4a is at least partially convexly curved and the second surface 4b is at least partially concavely curved.

In FIGS. 4 to 6, the central region 41 has an inner region 43, with respect to the radial direction Q, which contains the center axis M, and an outer region 44 adjoining the inner region 43 in the radial direction. The first surface 41a of the central region 41 is curved convexly in the inner region 43 and is curved concavely in the outer region 44. Accordingly, the second surface 41b of the central region 41 is curved concavely in the inner region 43 and is curved convexly in the outer region 44.

The connection region 42 here preferably continues the curvature profile of the central region 41, as is shown by way of example in FIGS. 4 to 6. Owing to the curvature of the outer region 44 of the central region 41, the connection region 42 of the pressure bulkhead 4 therefore extends along the center axis M of the pressure bulkhead 4 in the direction of the first region 21 of the fuselage vessel 2.

By means of the pressure bulkheads 4 shown in FIGS. 4 to 6, a pressure bulkhead is in each case realized, in which the direction of arching is changed twice between two points X1, X2 of a peripheral edge 40 of the pressure bulkhead 4, the points lying opposite each other in the radial direction Q. This means that contour lines of the first surface 4a and the second surface 4b of the pressure bulkhead 4 that arise in a section along an intersecting line between the points X1, X2 each have two turning points, wherein the points X1, X2 are each placed on a plane containing the center axis M. In other words, in a section of the pressure bulkhead 4 along an intersecting plane which contains the center axis M, a virtual connecting line V arises between two points X1, X2, lying in the sectional plane, of the peripheral edge of the pressure bulkhead 4. In FIGS. 4 to 6, the virtual connecting line V corresponds to the edge line 40. In the case of the pressure bulkheads 4 shown by way of example in FIGS. 4 to 6, two points 46, 47 in each case arise on one side of the virtual connecting line V at a maximum distance along the center axis M to the virtual connecting line V, the points being placed in each case inside the peripheral edge of the pressure bulkhead 4, with respect to the radial direction Q, i.e., at a certain distance A46, A47 and at a distance from the center axis M.

In a state in which one of the pressure bulkheads of FIGS. 4 to 6 is mounted in the fuselage vessel 2, the central region 41 of the pressure bulkhead 4 is arched in the inner region 43, with respect to the radial direction Q, in the direction of the first region 21 of the fuselage vessel 2 and is arched in the outer region 44, with respect to the radial direction Q, in the direction of the second region 22 of the fuselage vessel 2.

In FIG. 4, the inner region 43 of the central region 41 of the pressure bulkhead 4 is arched in a dome-like or spherical-segment-shaped manner. In the inner region 43 of the central region 41, the first surface 41a and the second surface 41b of the central region 41 each have a constant radius of curvature. As is furthermore shown by way of example in FIG. 4, it can be provided that the inner region 43 of the central region 41 of the pressure bulkhead 4 is arched to such an extent that the inner region projects with respect to the center axis M over the edge line 40 or the virtual connecting line V on the side opposite the points of maximum distance A46, A47. In the case of the pressure bulkhead 4 shown in FIG. 4, the central region 41 only projects by a very small amount beyond the edge line 40. It can also be provided that the apex point of the first surface 41a is placed level with the edge line 40 or the virtual connecting line V. This results in a highly compact, space-saving construction of the pressure bulkhead 4.

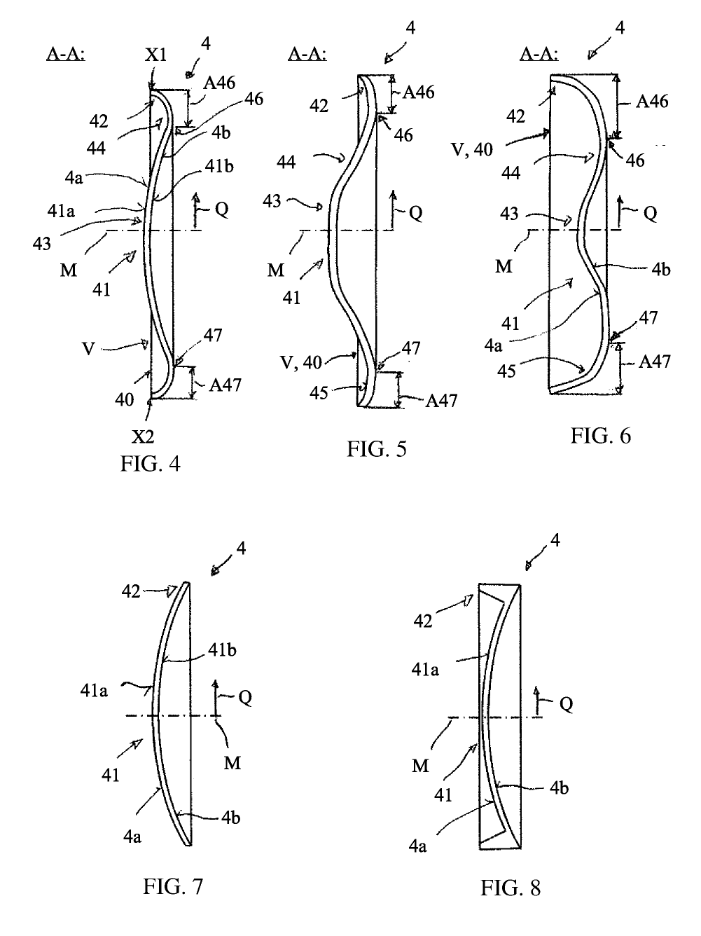

As is shown by way of example in FIG. 5, it can also be provided that the inner region 43 of the central region 41 of the pressure bulkhead 4 forms a plateau. In the region of the center axis M, the first 41a and the second surface 41b of the central region 41 each have a large radius of curvature or are even formed in a flat manner. The radius of curvature decreases radially outward. In the case of the pressure bulkhead 4 shown in FIG. 5, the central region 41 projects significantly beyond the edge line 40.

As is shown by way of example in FIG. 6, the inner region 43 of the central region 41 of the pressure bulkhead 4 can also be formed with an approximately constant radius of curvature. In contrast to FIGS. 4 and 5, the apex point of the first surface 41a of the central region 41 is placed on the same side of the edge line 40 or the virtual connecting line 40 as the points of maximum distance A46, A47.

FIGS. 7 and 8 in each case show by way of example a pressure bulkhead 4, in which the central region 41 is arched overall in a dome-like manner

In the case of the pressure bulkhead 4 shown by way of example in FIG. 7, the connection region 42 of the pressure bulkhead 4 continues the profile of the central region 41, in particular the curvature profile of the central region 41, in a planar manner

FIG. 8 shows, by way of example, a pressure bulkhead 4, in which the connection region 42 is of wedge-shaped design. In particular, the wedge projects in relation to the first, convexly curved surface 41a of the central region 41.

In general, the central region 41 and the connection region 42 of the pressure bulkhead 4 can be designed as two separate components which are connected to each other. However, the central region 41 and the connection region 42 are preferably formed integrally, as is also illustrated schematically in FIGS. 4 to 8.

The pressure bulkhead 4 can be formed, in particular, from a fiber composite material or a metal material.

The connection region 42 of the pressure bulkhead 4 can, in particular, have connection structures, such as recesses or projections (not illustrated) which are provided for receiving or for attaching securing devices. The connection region 42 can also be mechanically reinforced, for example by means of material accumulations, such as ribs or the like (not illustrated) or by means of additional reinforcing elements (not illustrated), such as fittings or the like.

Although the present invention has been explained above by way of example with reference to exemplary embodiments, it is not restricted thereto, but rather can be modified in diverse ways. In particular, combinations of the above exemplary embodiments are also conceivable.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 Fuselage structure
2 Fuselage vessel
2B End region of the fuselage vessel
2E Axial end of the fuselage vessel
4 Pressure bulkhead
4a First surface of the pressure bulkhead
4b Second surface of the pressure bulkhead
21 First region of the fuselage vessel
22 Second region of the fuselage vessel
25 Interior space
40 Edge line of the pressure bulkhead
41 Central region of the pressure bulkhead
41a First surface of the central region
41b Second surface of the central region
42 Connection region of the pressure bulkhead
43 Inner region of the central region
44 Outer region of the central region
45 Transition region
46,47 Points of maximum distance to the virtual connecting line
100 Aircraft
101 Passenger cabin
102 Cargo hold
105 System components
106 Lever arrangement
107 Control surface
D1 Distance
L Longitudinal direction
M Centre axis of the pressure bulkhead
P1 Internal pressure
P2 External pressure
Q Radial direction
V Virtual connecting line
X1,X2 Points of the peripheral edge

1. A fuselage structure for an aircraft, comprising:
a fuselage vessel extending in a longitudinal direction,
a pressure bulkhead arranged in an end region of the fuselage vessel and having a central region extending in a planar manner and a connection region adjoining the central region in a radial direction and surrounding said central region and being secured to the fuselage vessel;
wherein the pressure bulkhead divides the fuselage vessel with respect to the longitudinal direction into a first region for subjecting to an internal pressure and a second region for subjecting to an external pressure which is lower than the internal pressure; and
wherein the central region of the pressure bulkhead has an arching in a direction of the first region of the fuselage vessel.

2. The fuselage structure according to claim 1, wherein the direction of arching is changed twice between two points of a peripheral edge of the pressure bulkhead, said points lying opposite each other in a radial direction.

3. The fuselage structure according to claim 2, wherein the central region of the pressure bulkhead is arched in an inner region, with respect to the radial direction, in a direction of the first region of the fuselage vessel and is arched in an outer region, with respect to the radial direction, in a direction of the second region of the fuselage vessel.

4. The fuselage structure according to claim 2, wherein an inner region of the central region of the pressure bulkhead forms a plateau.

5. The fuselage structure according to claim 1, wherein the central region of the pressure bulkhead has a dome-like arching.

6. The fuselage structure according to claim 1, wherein the connection region of the pressure bulkhead continues a profile of the central region in a planar manner.

7. The fuselage structure according to claim 1, wherein the connection region is of wedge-shaped design.

8. The fuselage structure according to claim 1, wherein the central region and the connection region of the pressure bulkhead are formed integrally.

9. The fuselage structure according to claim 1, wherein the pressure bulkhead is formed from a fiber composite material or a metal material.

10. An aircraft comprising a fuselage structure according to claim 1.

11. The aircraft according to claim 10, wherein the first region of the fuselage vessel forms at least one of a passenger cabin or a cargo hold of the aircraft.

12. The aircraft according to claim 10, wherein system components, comprising a lever arrangement for actuating aerodynamic control surfaces of the aircraft, are arranged in the second region of the fuselage vessel.
